(19) United States
(12) Patent Application Publication
(10) Pub. No.: US 2026/0304314 A1
(43) Pub. Date: Oct. 1, 2026

(54) SCHEDULING TECHNIQUES FOR RADIO ACCESS TECHNOLOGY COEXISTENCE

(71) Applicant: QUALCOMM Incorporated, San Diego, CA (US)

(72) Inventors: Jian TAO, Shanghai (CN); Jinyong LIAO, Shanghai (CN); Jielin REN, Shanghai (CN); Dengke QIU, Shanghai (CN)

(21) Appl. No.: 19/100,901

(22) PCT Filed: Sep. 13, 2022
(86) PCT No.: PCT/CN2022/118388

§ 371 Date: Feb. 3, 2025

(51) Int. Cl. H04W 52/02; H04W 72/12; H04W 88/06

(52) U.S. Cl. CPC H04W 52/0216; H04W 72/1215; H04W 88/06

(57) ABSTRACT

Methods, systems, and devices for wireless communication are described. A station (STA) may transmit a first message to a first wireless device associated with a first radio access technology (RAT). The first message may indicate a time interval and a time window in the time interval that is available for communications between the STA and the wireless device via the first RAT. The STA may transmit a second message to an access point (AP) associated with a second RAT. The second message may indicate the time interval and a wake duration in the time interval that is available for communications between the STA and the AP via the second RAT. Accordingly, the STA may use the second RAT to communicate a first data message with the AP during the wake duration and the first RAT to communicate a second data message with the wireless device during the time window.

### CROSS REFERENCE

The present Application is a 371 national stage filing of International PCT Application No. PCT/CN2022/118388 by TAO et al. entitled “SCHEDULING TECHNIQUES FOR RADIO ACCESS TECHNOLOGY COEXISTENCE,” filed Sep. 13, 2022, which is assigned to the assignee hereof, and which is expressly incorporated by reference in its entirety herein.

### BACKGROUND

The following relates to wireless communication, including scheduling techniques for radio access technology (RAT) coexistence.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless local area network (WLAN), such as a Wi-Fi (e.g., Institute of Electrical and Electronics Engineers (IEEE) 802.11) network may include an access point (AP) that communicates with one or more stations (STAs) or mobile devices. The AP may be coupled to a network (such as the Internet) and may enable a mobile device to communicate with the network or other devices coupled to the AP. A wireless device may communicate with a network device bi-directionally. For example, in a WLAN, a STA may communicate with an associated AP via downlink and uplink. The downlink (or forward link) may refer to a communication link from the AP to the STA, while the uplink (or reverse link) may refer to a communication link from the STA to the AP.

In some wireless communications systems, multiple RATs may coexist (operate) in the same radio frequency (RF) spectrum band. Scheduling conflicts between RATs operating in the same RF spectrum band may result in degraded performance, higher latency, and increased signaling overhead.

### SUMMARY

The described techniques relate to improved methods, systems, devices, and apparatuses that support scheduling techniques for radio access technology (RAT) coexistence. More specifically, the described techniques provide for improving the performance of communication devices operating in a shared or unlicensed radio frequency (RF) spectrum band. In accordance with aspects of the present disclosure, a station (STA) may transmit a first message to a first wireless device associated with a first RAT. The first message may indicate a time interval and a time window in the time interval that is available for communications between the STA and the wireless device via the first RAT. The STA may transmit a second message to an access point (AP) associated with a second RAT. The second message may indicate the time interval and a wake duration in the time interval that is available for communications between the STA and the AP via the second RAT. Accordingly, the STA may use the second RAT to communicate a first data message with the AP during the wake duration, and may use the first RAT to communicate a second data message with the wireless device during the time window.

A method for wireless communication at a STA is described. The method may include transmitting, to a wireless device, a first message indicating a time interval and a time window in the time interval that is available for communications between the STA and the wireless device via a first RAT. The method may further include transmitting, to an AP, a second message indicating the time interval and a wake duration in the time interval that is available for communications between the STA and the AP via a second RAT, where the time window and the wake duration span different portions of the time interval. The method may further include communicating a data message with the AP during the wake duration via the second RAT.

An apparatus for wireless communication at a STA is described. The apparatus may include a processor, memory coupled with the processor, and instructions stored in the memory. The instructions may be executable by the processor to cause the apparatus to transmit, to a wireless device, a first message indicating a time interval and a time window in the time interval that is available for communications between the STA and the wireless device via a first RAT. The instructions may be further executable by the processor to cause the apparatus to transmit, to an AP, a second message indicating the time interval and a wake duration in the time interval that is available for communications between the STA and the AP via a second RAT, where the time window and the wake duration span different portions of the time interval. The instructions may be further executable by the processor to cause the apparatus to communicate a data message with the AP during the wake duration via the second RAT.

Another apparatus for wireless communication at a STA is described. The apparatus may include means for transmitting, to a wireless device, a first message indicating a time interval and a time window in the time interval that is available for communications between the STA and the wireless device via a first RAT. The apparatus may further include means for transmitting, to an AP, a second message indicating the time interval and a wake duration in the time interval that is available for communications between the STA and the AP via a second RAT, where the time window and the wake duration span different portions of the time interval. The apparatus may further include means for communicating a data message with the AP during the wake duration via the second RAT.

A non-transitory computer-readable medium storing code for wireless communication at a STA is described. The code may include instructions executable by a processor to transmit, to a wireless device, a first message indicating a time interval and a time window in the time interval that is available for communications between the STA and the wireless device via a first RAT. The instructions may be further executable by the processor to transmit, to an AP, a second message indicating the time interval and a wake duration in the time interval that is available for communications between the STA and the AP via a second RAT, where the time window and the wake duration span different portions of the time interval. The instructions may be further executable by the processor to communicate a data message with the AP during the wake duration via the second RAT.

Some examples of the method, apparatuses, and non-transitory computer-readable medium described herein may further include operations, features, means, or instructions for establishing a target wake time (TWT) session for the communications between the STA and the AP via the second RAT, where the data message is communicated with the AP during the TWT session.

In some examples of the method, apparatuses, and non-transitory computer-readable medium described herein, the TWT session may be established using one or more parameters associated with the communications between the STA and the wireless device via the first RAT.

In some examples of the method, apparatuses, and non-transitory computer-readable medium described herein, the TWT session may be established based on a capability of the STA to support coexistence between the first RAT and the second RAT.

In some examples of the method, apparatuses, and non-transitory computer-readable medium described herein, establishing the TWT session may include operations, features, means, or instructions for exchanging one or more TWT action frames with the AP, where the one or more TWT action frames indicate one or more parameters for the TWT session.

Some examples of the method, apparatuses, and non-transitory computer-readable medium described herein may further include operations, features, means, or instructions for communicating a second data message with the wireless device during the time window via the first RAT in accordance with an isochronous (ISO) data transport scheme.

In some examples of the method, apparatuses, and non-transitory computer-readable medium described herein, the second data message includes Bluetooth low energy (BLE) streaming data.

In some examples of the method, apparatuses, and non-transitory computer-readable medium described herein, the data message may be communicated during the wake duration in accordance with a periodic data transport scheme associated with the second RAT.

In some examples of the method, apparatuses, and non-transitory computer-readable medium described herein, the data message may be communicated in accordance with a wireless local area network (WLAN) frame exchange, where the data message includes a power management (PM) bit set to a first value.

In some examples of the method, apparatuses, and non-transitory computer-readable medium described herein, the first RAT includes a Bluetooth RAT and the second RAT includes a WLAN RAT.

In some examples of the method, apparatuses, and non-transitory computer-readable medium described herein, the wake duration may be equal to a difference between a duration of the time interval and a duration of the time window.

In some examples of the method, apparatuses, and non-transitory computer-readable medium described herein, the time window may span a first portion of the time interval and the wake duration may span a remaining portion of the time interval.

A method for wireless communication at an AP is described. The method may include receiving, from a STA, a first message that indicates a time interval and a wake duration in the time interval that is available for communications between the AP and the STA via a second RAT, where the wake duration is based on a time window in the time interval that is available for communications between the STA and a wireless device via a first RAT. The method may further include communicating a data message with the STA during the wake duration via the second RAT, where the time window and the wake duration span different portions of the time interval.

An apparatus for wireless communication at an AP is described. The apparatus may include a processor, memory coupled with the processor, and instructions stored in the memory. The instructions may be executable by the processor to cause the apparatus to receive, from a STA, a first message that indicates a time interval and a wake duration in the time interval that is available for communications between the AP and the STA via a second RAT, where the wake duration is based on a time window in the time interval that is available for communications between the STA and a wireless device via a first RAT. The instructions may be further executable by the processor to cause the apparatus to communicate a data message with the STA during the wake duration via the second RAT, where the time window and the wake duration span different portions of the time interval.

Another apparatus for wireless communication at an AP is described. The apparatus may include means for receiving, from a STA, a first message that indicates a time interval and a wake duration in the time interval that is available for communications between the AP and the STA via a second RAT, where the wake duration is based on a time window in the time interval that is available for communications between the STA and a wireless device via a first RAT. The apparatus may further include means for communicating a data message with the STA during the wake duration via the second RAT, where the time window and the wake duration span different portions of the time interval.

A non-transitory computer-readable medium storing code for wireless communication at an AP is described. The code may include instructions executable by a processor to receive, from a STA, a first message that indicates a time interval and a wake duration in the time interval that is available for communications between the AP and the STA via a second RAT, where the wake duration is based on a time window in the time interval that is available for communications between the STA and a wireless device via a first RAT. The instructions may be further executable by the processor to communicate a data message with the STA during the wake duration via the second RAT, where the time window and the wake duration span different portions of the time interval.

Some examples of the method, apparatuses, and non-transitory computer-readable medium described herein may further include operations, features, means, or instructions for establishing a TWT session for the communications between the STA and the AP via the second RAT, where the data message is communicated with the STA during the TWT session.

In some examples of the method, apparatuses, and non-transitory computer-readable medium described herein, the TWT session may be established using one or more parameters associated with the communications between the STA and the wireless device via the first RAT.

In some examples of the method, apparatuses, and non-transitory computer-readable medium described herein, the TWT session may be established based on a capability of the STA to support coexistence between the first RAT and the second RAT.

In some examples of the method, apparatuses, and non-transitory computer-readable medium described herein, establishing the TWT session may include operations, features, means, or instructions for exchanging one or more TWT action frames with the STA, where the one or more TWT action frames indicate one or more parameters for the TWT session.

In some examples of the method, apparatuses, and non-transitory computer-readable medium described herein, the data message may be communicated during the wake duration in accordance with a periodic data transport scheme associated with the second RAT.

In some examples of the method, apparatuses, and non-transitory computer-readable medium described herein, the data message may be communicated in accordance with a WLAN frame exchange, where the data message includes a PM bit set to a first value.

In some examples of the method, apparatuses, and non-transitory computer-readable medium described herein, the first RAT includes a Bluetooth RAT and the second RAT includes a WLAN RAT.

In some examples of the method, apparatuses, and non-transitory computer-readable medium described herein, the wake duration may be equal to a difference between a duration of the time interval and a duration of the time window.

In some examples of the method, apparatuses, and non-transitory computer-readable medium described herein, the time window may span a first portion of the time interval and the wake duration may span a remaining portion of the time interval.

### BRIEF DESCRIPTION OF THE DRAWINGS

FIGS. 1 and 2 illustrate examples of wireless communications systems that support scheduling techniques for radio access technology (RAT) coexistence in accordance with one or more aspects of the present disclosure.

FIG. 3 illustrates an example of a communication timeline that supports scheduling techniques for RAT coexistence in accordance with one or more aspects of the present disclosure.

FIGS. 4A, 4B, and 4C illustrate examples of communication timelines that support scheduling techniques for RAT coexistence in accordance with one or more aspects of the present disclosure.

FIGS. 5 and 6 illustrate examples of communication timelines that support scheduling techniques for RAT coexistence in accordance with one or more aspects of the present disclosure.

FIG. 7 illustrates an example of a process flow that supports scheduling techniques for RAT coexistence in accordance with one or more aspects of the present disclosure.

FIGS. 8 and 9 show block diagrams of devices that support scheduling techniques for RAT coexistence in accordance with one or more aspects of the present disclosure.

FIG. 10 shows a block diagram of a communications manager that supports scheduling techniques for RAT coexistence in accordance with one or more aspects of the present disclosure.

FIG. 11 shows a diagram of a system including a device that supports scheduling techniques for RAT coexistence in accordance with one or more aspects of the present disclosure.

FIGS. 12 and 13 show block diagrams of devices that support scheduling techniques for RAT coexistence in accordance with one or more aspects of the present disclosure.

FIG. 14 shows a block diagram of a communications manager that supports scheduling techniques for RAT coexistence in accordance with one or more aspects of the present disclosure.

FIG. 15 shows a diagram of a system including a device that supports scheduling techniques for RAT coexistence in accordance with one or more aspects of the present disclosure.

FIGS. 16 through 19 show flowcharts illustrating methods that support scheduling techniques for RAT coexistence in accordance with one or more aspects of the present disclosure.

### DETAILED DESCRIPTION

Some communication devices with Bluetooth capabilities may support low energy (LE) audio stream transport schemes, which may enable communication devices to perform audio streaming with relatively lower peak power levels (in comparison to other Bluetooth audio transport schemes). Communication devices may stream Bluetooth Low Energy (BLE) audio data using an isochronous (ISO) data transport mechanism, which may be defined by a series of active durations (referred to as ISO windows) and inactive durations (referred to as ISO durations) within a periodic time interval (equivalently referred to as an ISO interval). In some cases, however, communicating BLE audio data in a shared or unlicensed radio frequency (RF) spectrum band that is accessible to other radio access technologies (RATs) may result in scheduling conflicts and signaling collisions that adversely impact the quality and reliability of wireless communications associated with other RATs.

Aspects of the present disclosure may support coexistence between RATs in a shared or unlicensed RF spectrum band. In accordance with the techniques described herein, a station (STA) may transmit a first message to a wireless device associated with a first RAT. The first message may indicate a first interval and a time window in the first interval that is available for communications between the STA and the wireless device via the first RAT. The STA may also transmit a second message to an access point (AP) associated with a second RAT. The second message may indicate a second time interval and a wake duration in the second time interval that is available for communications between the STA and the AP via the second RAT. The STA may configure the second time interval such that the first time interval and the second time interval have the same duration and start time. The STA may configure the wake duration such that the time window and the wake duration span different (non-overlapping) portions of the first time interval.

Configuring the time window and the wake duration such that communications between the STA and the wireless device do not overlap with communications between the STA and the AP may reduce the likelihood of the communications with the wireless device interfering with or otherwise degrading the performance of the communications with the AP, thereby enabling the STA and the AP to communicate with improved communication reliability, reduced latency, and reduced signaling overhead (for example, by reducing interference and delays caused by scheduling conflicts between RATs).

In some examples, the first RAT may be an example of a Bluetooth RAT and the second RAT may be an example of a wireless local area network (WLAN) RAT such as Wi-Fi. In such examples, the first time interval may be an example of an ISO interval, the time window may be an example of an ISO window available for BLE audio streaming data transport between the STA and the wireless device, the second time interval may be an example of a target wake time (TWT) wake interval, and the wake duration may be an example of a TWT wake duration available for WLAN traffic between the STA and the AP. The STA may configure the ISO parameters (ISO window, ISO interval, ISO start time) and the TWT parameters (TWT wake interval, TWT wake duration, TWT start time) based on a capability of the STA to support coexistence between Bluetooth and WLAN. In some examples, Bluetooth communications between the STA and the wireless device may have a higher priority than WLAN communications between the STA and the AP.

Performing WLAN communications and Bluetooth communications in separate time intervals may reduce the likelihood of the STA dropping or delaying WLAN communications due to scheduling conflicts with Bluetooth communications (which the STA may prioritize in the event of an overlap between the two RATs), resulting in fewer retransmissions, reduced power consumption, and lower signaling overhead at the STA (in comparison to other coexistence schemes). Moreover, performing WLAN communications in an idle or unused portion of an ISO interval (e.g., an ISO duration) may decrease the communication resource overhead associated with the Bluetooth communications between the STA and the wireless device.

Aspects of the disclosure are initially described in the context of wireless communications systems, Aspects of the disclosure are further illustrated by and described with reference to apparatus diagrams, system diagrams, and flowcharts that relate to scheduling techniques for RAT coexistence.

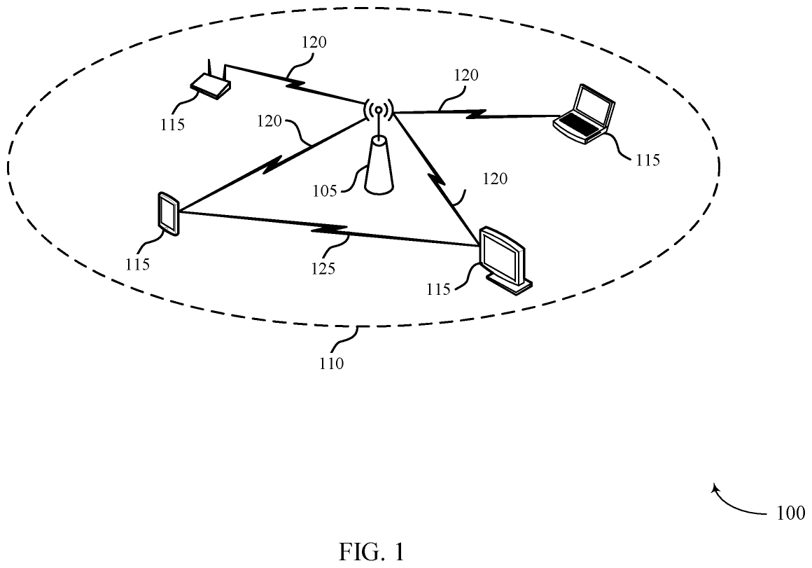

FIG. 1 illustrates a wireless communications system 100 (also referred to as a Wi-Fi network or a WLAN) configured in accordance with various aspects of the present disclosure. The wireless communications system 100 may include an AP 105 and multiple associated STAs 115, which may represent devices such as mobile STAs, personal digital assistant (PDAs), other handheld devices, netbooks, notebook computers, tablet computers, laptops, display devices (e.g., televisions (TVs), computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the wireless communications system 100. An extended network STA (not shown) associated with the wireless communications system 100 may be connected to a wired or wireless distribution system that may allow multiple APs 105 to be connected in an ESS.

In accordance with the techniques and operations described herein, a STA 115 may transmit a first message to a first wireless device (e.g., another STA 115) that supports a first RAT (e.g., Bluetooth). The first message may indicate a time interval and a time window in the time interval that is available for communications between the STA 115 and the wireless device via the first RAT. The STA 115 may transmit a second message to an AP 105 associated with a second RAT (e.g., Wi-Fi). The second message may indicate the time interval and a wake duration in the time interval that is available for communications between the STA 115 and the AP 105 via the second RAT. Accordingly, the STA 115 may use the second RAT to communicate a first data message with the AP 105 during the wake duration, and may use the first RAT to communicate a second data message with the wireless device during the time window.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The wireless communications system 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and medium access control (MAC) layers from Institute of Electrical and Electronics Engineers (IEEE) 802.11 and versions including, but not limited to, 802.11b, 802.11g, 802.11a, 802.11n, 802.11ac, 802.11ad, 802.11ah, 802.11ax, etc. In other implementations, peer-to-peer connections or ad-hoc networks may be implemented within the wireless communications system 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention-based environment that employs carrier-sense multiple access with collision avoidance (CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of a request-to-send (RTS) packet transmitted by a sending STA 115 (or AP 105) and a clear-to-send (CTS) packet transmitted by the receiving STA 115 (or AP 105). This may alert other devices within range of the sender and receiver not to transmit for the duration of the primary transmission. Thus, RTS/CTS may help mitigate a hidden node problem.

Aspects of the wireless communications system 100 may be implemented to realize one or more of the following advantages. The techniques and operations described with reference to FIG. 1 may enable a STA 115 and an AP 105 to exchange WLAN traffic (also referred to as data messages or communications) with reduced latency, higher signal quality, and lower signaling overhead, among other benefits. For example, configuring TWT parameters and ISO parameters such that a TWT wake duration (used for WLAN traffic) and an ISO window (used for BLE traffic) occupy non-overlapping portions of an ISO interval may reduce the likelihood of scheduling conflicts between WLAN and Bluetooth communications, thereby increasing the likelihood of the STA 115 and the AP 105 successfully exchanging WLAN communications in the TWT wake duration.

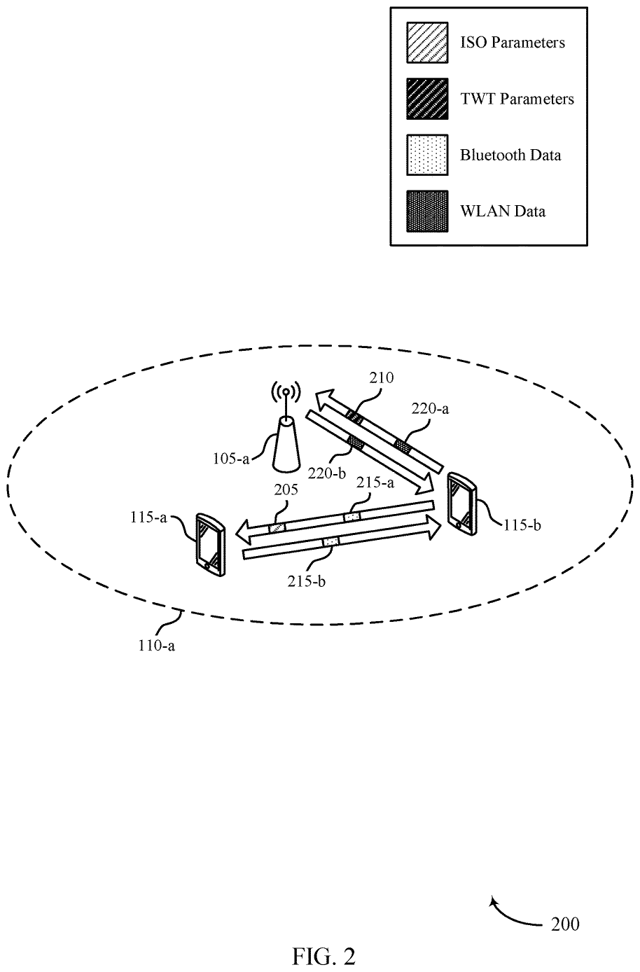

FIG. 2 illustrates an example of a wireless communications system 200 that supports scheduling techniques for RAT coexistence in accordance with one or more aspects of the present disclosure. The wireless communications system 200 may implement or be implemented by aspects of the wireless communications system 100. For example, the wireless communications system 200 may include an AP 105-a, a STA 115-a, and a STA 115-b, which may be examples of corresponding devices described with reference to FIG. 1. The devices of the wireless communications system 200 may communicate within a coverage area 110-a, which may be an example of the coverage area 110 described with reference to FIG. 1. In the wireless communications system 200, the STA 115-b may use a coexistence scheme to communicate with the AP 105-a (using a WLAN RAT) and the STA 115-a (using a Bluetooth RAT).

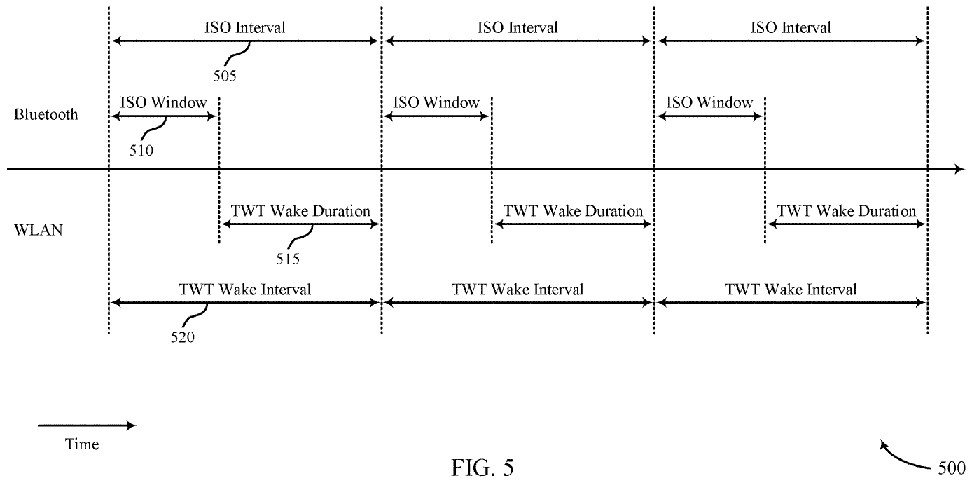

In the example of FIG. 2, the STA 115-b may transmit an indication of ISO parameters 205 to the STA 115-a. The ISO parameters may include, for example, an ISO interval (e.g., the ISO interval 505 described with reference to FIG. 5), an ISO window (e.g., the ISO window 510 described with reference to FIG. 5), an ISO start time, etc. The STA 115-b may use the ISO parameters to communicate BLE audio streaming data with the STA 115-b in accordance with a periodic ISO data transfer scheme. For example, the STA 115-b may transmit Bluetooth data 215-a (a first set of PDUs carrying BLE audio streaming data) to the STA 115-a during an ISO window of an ISO interval. Additionally, or alternatively, the STA 115-b may receive Bluetooth data 215-b (a second set of PDUs carrying BLE audio streaming data) from the STA 115-a during the ISO window of the ISO interval.

The STA 115-b may also transmit an indication of TWT parameters 210 to the AP 105-a. The TWT parameters 210 may include, for example, a TWT wake interval (e.g., the TWT wake interval 520 described with reference to FIG. 5), a TWT wake duration (e.g., the TWT wake duration 515 described with reference to FIG. 5), and various other TWT setup parameters. The STA 115-b may transmit the indication of the TWT parameters 210 via a TWT action frame exchange with the AP 105-a. Accordingly, the STA 115-b may establish a TWT session with the AP 105-a based on the TWT parameters 210.

The TWT session may be configured such that the TWT wake interval and the ISO interval have the same duration and start time. The TWT session may also be configured such that the TWT wake duration and the ISO window occupy different (non-overlapping) portions of the ISO window. In other words, the STA 115-b may configure the TWT session such that Bluetooth communications (between the STA 115-b and the STA 115-a) and WLAN communications (between the STA 115-b and the AP 105-a) are performed in different time periods.

Once the STA 115-b has established a TWT session with the AP 105-a, the STA 115-b may periodically communicate WLAN data with the AP 105-a during one or more TWT wake durations. For example, the STA 115-b may transmit WLAN data 220-a (uplink traffic) to the AP 105-a or receive WLAN data 220-b (downlink traffic) from the AP 105-a during each TWT wake duration. In some examples, the WLAN data 220-a and the WLAN data 220-b may include a power management (PM) bit set to 1.

Configuring the TWT session such that Bluetooth communications and WLAN communications are performed at separate times may result in higher throughput, reduced interference, and greater communication reliability by reducing the likelihood of Bluetooth communications (between the STAs 115) interfering with WLAN communications (between the STA 115-b and the AP 105-a).

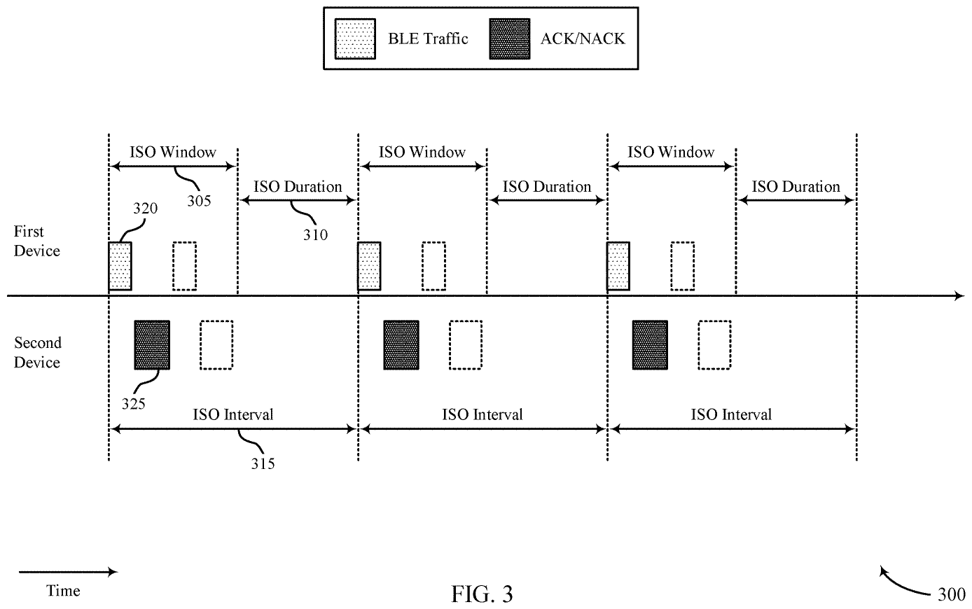

FIG. 3 illustrates an example of a communication timeline 300 that supports scheduling techniques for RAT coexistence in accordance with one or more aspects of the present disclosure. The communication timeline 300 may implement or be implemented by aspects of the wireless communications system 100 or the wireless communications system 200. For example, the communication timeline 300 may be implemented by a STA 115 or an AP 105, as described with reference to FIGS. 1 and 2. The communication timeline 300 may illustrate communications between a first (master) device and a second (slave) device associated with a Bluetooth RAT.

LE audio, also referred to as next-generation Bluetooth Audio, may enable audio streaming over BLE with reduced power consumption in comparison to classic basic rate (BR) or enhanced data rate (EDR) Bluetooth audio transport schemes. BLE audio streaming data may be communicated in the form of packets that include a connected ISO protocol data unit (PDU) header or a broadcast ISO PDU header.

A connected ISO PDU header may include a link layer identifier (LLID) field of 2 bits, a next expected sequence number (NESN) field of 1 bit, a sequence number (SN) field of 1 bit, a close isochronous event (CIE) field of 1 bit, a first reserved for future use (RFU) field of 1 bit, a null PDU indicator (NPI) field of 1 bit, a second RFU field of 1 bit, and a length field of 8 bits. A broadcast ISO PDU header may include an LLID field of 2 bits, a control sub-event sequence number (CSSN) field of 3 bits, a control sub-event transmission flag (CSTF) field of 1 bit, an RFU field of 2 bits, and a length field of 8 bits. A framed PDU may include one or more segmentation headers, time offset segments, and ISO service data unit (SDU) segments, among other examples.

In some cases, a WLAN RAT (such as Wi-Fi) and a Bluetooth RAT may both operate in the same RF spectrum band (such as a 2.4 GHz unlicensed band), which may introduce performance and quality of service (QOS) challenges. For example, if Bluetooth communications have a higher priority than WLAN communications, Bluetooth ISO traffic (which may include BLE audio streaming data) may supersede WLAN traffic in the event of scheduling conflicts. As a result, WLAN devices may experience degraded performance, decreased throughput, and higher latency. Aspects of the present disclosure provide for using a standardized Wi-Fi protocol (e.g., 802.11ax) to support coexistence between WLAN and Bluetooth in a shared or unlicensed frequency band.

A LE audio stream transport protocol may use ISO data transfer over BLE to support lower peak power constraints. In the example of FIG. 3, the ISO interval 315 represents the interval of ISO data transfer, the length of which may vary from 5 ms to 4 s. The ISO window 305 represent the timeslot in which Bluetooth communications are performed within the ISO interval 315. For example, the first (master) device may transmit a data message 320 (P0) to the second (slave) device during the ISO window 305.

Accordingly, the second device may transmit acknowledgement (ACK) or negative acknowledgement (NACK) feedback 325 for the data message 320 to the first device during ISO window 305. The ISO duration 310 may refer to an idle slot (portion) within the ISO interval 315. Bluetooth ISO data transport may be a periodic or recurring process. As such, the first device may transmit a second data message (P1) in the next ISO window, a third data message (P2) in the following ISO window, etc. These data messages (also referred to as PDUs or packets) may include BLE audio streaming data.

Aspects of the communication timeline 300 may be implemented to realize one or more of the following advantages. The techniques and operations described with reference to FIG. 3 may enable a STA and an AP to exchange WLAN traffic with reduced latency, higher signal quality, and lower signaling overhead, among other benefits. For example, configuring TWT parameters and ISO parameters such that a TWT wake duration (used for WLAN traffic) and the ISO window 305 (used for Bluetooth traffic) occupy non-overlapping portions of the ISO interval 315 may reduce the likelihood of scheduling conflicts between WLAN and Bluetooth communications, thereby increasing the likelihood of the STA and the AP successfully performing WLAN communications in the TWT wake duration.

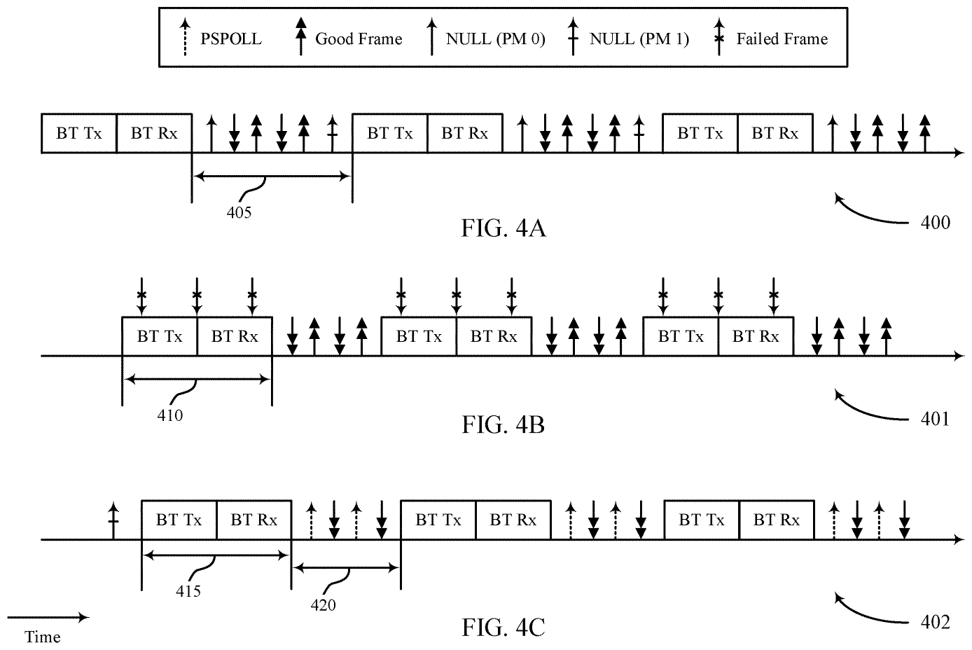

FIGS. 4A, 4B, and 4C illustrate examples of a communication timeline 400, a communication timeline 401, and a communication timeline 402 that support scheduling techniques for RAT coexistence in accordance with one or more aspects of the present disclosure. The communication timelines illustrated in FIGS. 4A, 4B, and 4C may implement or be implemented by aspects of any of the wireless communications systems, or communication timelines described with reference to FIGS. 1 through 3. For example, one or more of the communication timeline 400, the communication timeline 401, or the communication timeline 402 may be implemented by a STA 115 or an AP 105, as described with reference to FIGS. 1 and 2.

FIG. 4A illustrates an example of a coexistence scheme (between WLAN and Bluetooth) in which an ISO duration 405 (e.g., a period of Bluetooth inactivity) is greater than 17 ms. In such cases, a coexistence algorithm may be used to implement traffic shaping and maintain a relatively high downlink throughput rate. However, this approach may introduce signaling overhead, as a STA may have to perform an over-the-air (OTA) handshake procedure with an AP by setting a PM bit in a QoS Null frame to 0 or 1. Thus, using a handshake procedure may result in degraded WLAN throughput. Additionally, this approach may introduce interoperability (IOP) issues for some APs that are unable to process QoS Null frames properly, which may further decrease WLAN throughput levels.

FIG. 4B illustrates an example of a coexistence scheme in which an ISO window 410 is less than 4 ms. When using a free-run policy for RAT coexistence, WLAN downlink data transport may be adversely affected due to the higher priority of BLE traffic when there are collisions or conflicts between Bluetooth and WLAN. In such cases, WLAN downlink throughput may experience degraded performance and higher retransmission rates (at the AP side). Moreover, data stalls (which may be relatively difficult to recover from) may occur when the data rate of an AP drops below a threshold of 1 Megabit per second (Mbps).

FIG. 4C illustrates an example of a coexistence scheme in which an ISO duration 420 is less than 17 ms and an ISO window 415 is greater than 4 ms. In such cases, a WLAN coexistence protocol may use a power save poll (PS-POLL) packet to trigger downlink data from an AP. However, this approach may result in lower downlink throughput levels for WLAN. Also, some APs may have difficulties responding to PS-POLL packets, which could result in data stalls.

Aspects of the communication timeline 400, the communication timeline 401, and the communication timeline 402 may be implemented to realize one or more of the following advantages. The techniques and operations described with reference to FIGS. 4A, 4B, and 4C may enable a STA to perform WLAN communications with reduced latency, higher signal quality, and lower signaling overhead by reducing the likelihood of Bluetooth communications (e.g., BLE audio streaming traffic) interfering with or otherwise degrading the quality of the WLAN communications. More specifically, the STA may configure one or more TWT parameters and ISO parameters such that the Bluetooth communications (between the STA and another wireless device) and the WLAN communications (between the STA and an AP) are performed in non-overlapping time periods, thereby decreasing the probability of scheduling conflicts between the Bluetooth communications and the WLAN communications.

FIG. 5 illustrates an example of a communication timeline 500 that supports scheduling techniques for RAT coexistence in accordance with one or more aspects of the present disclosure. The communication timeline 500 may implement or be implemented by aspects of any of the wireless communications systems or communication timelines described with reference to FIGS. 1 through 4. For example, the communication timeline 500 may be implemented by a STA 115 or an AP 105, as described with reference to FIGS. 1 and 2. In the communication timeline 500, a STA may establish a TWT session for WLAN communications between the STA and an AP using TWT parameters that are based on ISO parameters used for Bluetooth communications between the STA and another wireless device.

Some wireless communications systems may support coexistence between WLAN and BLE audio (e.g., ISO coexistence). When WLAN and Bluetooth radios are operating on the same co-located device, the device (a STA) may have to comply with coexistence regulations related to the quality of Bluetooth and WLAN communications. In some coexistence scenarios, Bluetooth ISO traffic may have a higher priority than WLAN traffic. As such, the WLAN radio of the device may use idle slots within an ISO interval 505 to transmit and receive WLAN data, and may yield the wireless medium to the Bluetooth radio during an ISO window 510 within the ISO interval 505. Prioritizing Bluetooth traffic over WLAN traffic (when collisions or conflicts occur) may enable the device to perform BLE audio data transport with relatively low latency and relatively high signal quality.

As described herein, Bluetooth ISO data transport may have an associated periodicity. A TWT protocol (used to configure WLAN activity) may also be associated with periodic air interface behavior. The techniques described herein support a coexistence algorithm that uses the TWT protocol to schedule WLAN and BLE traffic, as TWT scheduling is periodic (similar to BLE audio streaming). To support the techniques described herein, a STA may use WLAN coexistence software to setup a TWT session with an AP (via a coexistence interface) based on BLE ISO parameters such as ISO window, ISO interval, start time, etc.

In the example of FIG. 5, a TWT wake interval 520 may be set as the ISO interval 505. A TWT wake duration 515, also referred to as a TWT service period (SP) may be set as the difference between the ISO interval 505 and the ISO window 510 (ISO interval—ISO window). Using a coexistence algorithm, the STA may setup the TWT session based on BLE ISO parameters (ISO window, ISO interval, start time). After the TWT setup complete, the STA and the AP may exchange WLAN frames (with a PM bit set to 1) during each TWT wake duration 515.

Aspects of the communication timeline 500 may be implemented to realize one or more of the following advantages. The techniques and operations described with reference to FIG. 5 may enable a STA and an AP to exchange WLAN traffic with reduced latency, higher signal quality, and lower signaling overhead, among other benefits. For example, configuring TWT parameters and ISO parameters such that the TWT wake duration 515 (used for WLAN traffic) and the ISO window 510 (used for BLE traffic) occupy non-overlapping portions of the ISO interval 505 may reduce the likelihood of scheduling conflicts between WLAN and Bluetooth communications, thereby increasing the likelihood of the STA and the AP successfully communicating WLAN data in the TWT wake duration 515.

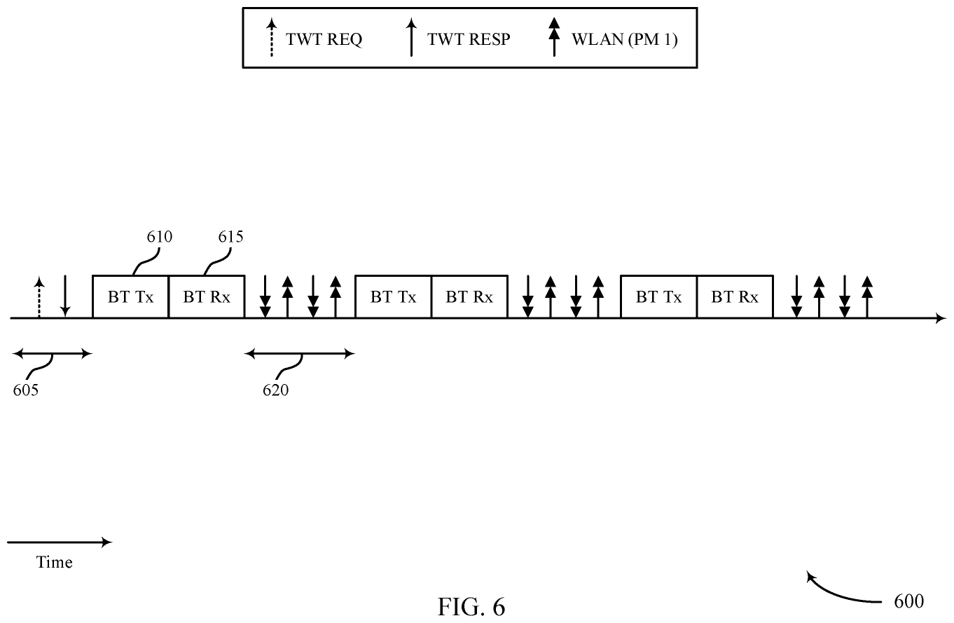

FIG. 6 illustrates an example of a communication timeline 600 that supports scheduling techniques for RAT coexistence in accordance with one or more aspects of the present disclosure. The communication timeline 600 may implement or be implemented by aspects of any of the wireless communications systems or communication timelines described with reference to FIGS. 1 through 5. For example, the communication timeline 500 may be implemented by a STA 115 or an AP 105, as described with reference to FIGS. 1 and 2. The communication timeline 600 may include TWT action frames 605, Bluetooth transmit frames 610, Bluetooth receive frames 615, and a TWT wake duration 620. The Bluetooth transmit frames 610 and the Bluetooth receive frames 615 may collectively form an ISO window, which may be an example of the ISO window 510 described with reference to FIG. 5. The TWT wake duration 620 may be an example of the TWT wake duration 515 described with reference to FIG. 5.

Bluetooth devices may exchange or advertise TWT capabilities using a high efficiency (HE) capabilities information element (IE) present in one or more of a beacon frame, a probe request or response frame, or a (re)association request or response frame. The HE capabilities IE may include an element ID segment of 1 octet, a length segment of 1 octet, an element ID extension segment of 1 octet, a HE MAC capabilities information segment of 5 octets, a HE PHY capabilities information segment of 9 octets, a transmit or receive HE modulation and coding scheme (MCS) network security services (NSS) support segment of two or more octets, and an optional PHY packet extension (PPE) threshold segment that includes a variable number of octets.

Among other fields, the HE MAC capabilities information segment may include a TWT requester support field of 1 bit, a TWT responder support field of 1 bit, a broadcast TWT support field of 1 bit, and a flexible TWT schedule support field of 1 bit. The TWT requester support field may indicate whether an AP or STA supports individual (unicast) TWT as the requesting device or requester (e.g., a non-AP STA). The TWT responder support field may indicate whether an AP or STA supports individual TWT as the responding device or controller (e.g., an AP).

The broadcast TWT support field may indicate whether the STA or AP (depending on which device is transmitting the frame) supports broadcast TWT. The flexible TWT schedule support field may indicate a start time of the next TWT SP. If the flexible TWT schedule support field is set to 0, the start time of the next TWT SP may be selected from existing TWT values. Alternatively, if the flexible TWT schedule support field is set to 1, the start time of the next TWT SP may be set to any value.

The HE operation IE may be present in a beacon frame, a probe response frame, or a (re)association response frame, among other examples. The HE operation IE may include a HE operation parameters segment of 4 octets, which may include a TWT required field of 1 bit. An AP may use the TWT required field to configure non-AP HE STAs to operate as a TWT requesting STA or a TWT scheduled STA. In such examples, a STA may request or negotiate (select) individual TWT usage with an AP. Additionally, or alternatively, a STA may participate in a broadcast TWT session configured by an AP.

A TWT IE may be present in TWT setup frames, beacon or probe response frames, or (re)association request or response frames, among other examples. The TWT IE may include (among other segments) a request type segment of 2 octets, a nominal minimum TWT wake duration segment (in units of 256 μs) of 1 octet, and a TWT wake interval mantissa segment of 2 octets. The request type segment may include (among other fields) a TWT request field of 1 bit, a TWT setup command field of 3 bits, a flow type field of 1 bit, and a TWT wake interval exponent field of 5 bits. A STA may set the TWT request field to 1, whereas an AP may set the TWT request field to 0.

A STA may use the TWT setup command field to request, suggest, or demand a TWT session. An AP may use the TWT setup command field to accept, alternate, dictate, or reject a TWT session. The flow type field may indicate whether a TWT session is announced or unannounced. The duration of a TWT wake interval (in us) may be calculated based on information from the TWT wake interval mantissa segment and a value of the TWT wake interval exponent field.

The TWT action frames 605 may include TWT setup frames, TWT teardown frames, and TWT information frames. The TWT setup frames may be used to setup or teardown individual or broadcast TWT sessions. The TWT teardown frames may be used to tear down individual (unicast) TWT sessions. The TWT information frames may be used to pause or resume a TWT session. If used to pause a TWT session, one or more next TWT fields may be absent from the TWT information frames. If used to resume a TWT session, the one or more next TWT fields may indicate the start of the next TWT SP.

Aspects of the communication timeline 600 may be implemented to realize one or more of the following advantages. The techniques and operations described with reference to FIG. 6 may enable a STA to perform WLAN communications with reduced latency, higher signal quality, and lower signaling overhead by reducing the likelihood of Bluetooth communications (e.g., BLE audio streaming traffic) interfering with or otherwise degrading the quality of the WLAN communications. More specifically, the STA may configure one or more TWT parameters (via the TWT action frames 605) and ISO parameters such that the Bluetooth communications and the WLAN communications are performed in non-overlapping time periods, thereby decreasing the probability of scheduling conflicts between the Bluetooth communications and the WLAN communications.

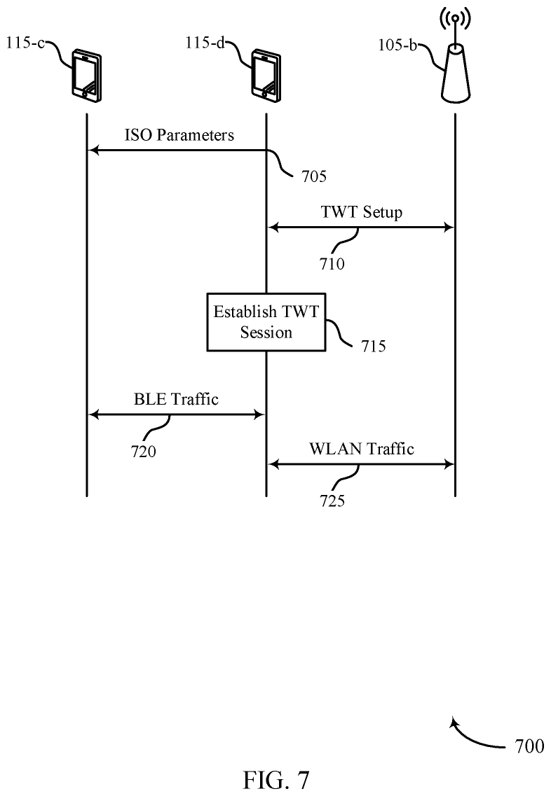

FIG. 7 illustrates an example of a process flow 700 that supports scheduling techniques for RAT coexistence in accordance with one or more aspects of the present disclosure. The process flow 700 may implement or be implemented by aspects of any of the wireless communications systems or communication timelines described with reference to FIGS. 1 through 6. For example, the process flow 700 may include a STA 115-c, a STA 115-d, and an AP 105-b, which may be examples of corresponding devices described with reference to FIGS. 1 and 2. In the following description of the process flow 700, operations between the AP 105-b and the STAs 115 may be added, omitted, or performed in a different order (with respect to the exemplary order shown).

At 705, the STA 115-d may transmit an indication of one or more ISO parameters to the STA 115-c. Although not depicted in the example of FIG. 7, it is to be understood that the STA 115-d may also receive an indication of corresponding ISO parameters from the STA 115-c (e.g., the ISO parameters may be jointly configured by the STAs 115). The ISO parameters may include a first time interval (e.g., the ISO interval 505 described with reference to FIG. 5) and a time window (e.g., the ISO window 510 described with reference to FIG. 5) within the first time interval that is available for communications between the STA 115-d and the STA 115-c via a first RAT (e.g., a Bluetooth RAT). In some examples, the ISO parameters may also include a start time or other ISO data transport parameters not explicitly mentioned herein.

At 710, the STA 115-d may transmit an indication of one or more TWT parameters to the AP 105-b during a TWT action frame exchange (e.g., a TWT setup procedure). The TWT parameters may include a second time interval (e.g., the TWT wake interval 520 described with reference to FIG. 5) and a wake duration in the second time interval (e.g., the TWT wake duration 515 described with reference to FIG. 5) that is available for communications between the STA 115-d and the AP 105-b via a second RAT (e.g., a WLAN RAT). The STA 115-d may select or otherwise determine the TWT parameters based on the ISO parameters signaled to the STA 115-c.

As described herein, the wake duration (in the second time interval) and the time window (in the first time interval) may be non-overlapping in time. For example, the time window may span a first portion of the first time interval, and the wake duration may span a remaining portion of the first time interval. That is, the wake duration may be equal to a difference between the first time interval and the time window. The first time interval and the second time interval may have corresponding (equivalent) start times and durations.

At 715, the STA 115-d may establish a TWT session for communications with the AP 105-b based on the one or more TWT parameters. In some examples, the STA 115-d may establish the TWT session based on a capability of the STA 115-d to support coexistence between the first RAT and the second RAT.

At 720, the STA 115-d may communicate Bluetooth traffic (e.g., BLE audio streaming data) with the STA 115-c in accordance with a periodic ISO data transport scheme, as described with reference to FIG. 3. In some examples, the STA 115-d may be designated as a master device for the Bluetooth communications between the STAs 115. In other examples, the STA 115-c may designated as the master device.

At 725, the STA 115-d may use the second RAT to communicate with the AP 105-b during the wake duration of the second time interval. For example, the STA 115-d may transmit WLAN traffic (uplink data) to the AP 105-b or receive WLAN traffic (downlink data) from the AP 105-b in accordance with the previously established TWT session. In some examples, the STA 115-d may set a PM bit to 1 for WLAN communications with the AP 105-b.

Aspects of the process flow 700 may be implemented to realize one or more of the following advantages. The techniques and operations described with reference to FIG. 7 may enable the STA 115-d to perform WLAN communications with reduced latency, higher signal quality, and lower signaling overhead by reducing the likelihood of Bluetooth communications (e.g., BLE audio streaming traffic) interfering with or otherwise degrading the quality of the WLAN communications. More specifically, the STA 115-d may configure one or more TWT parameters and ISO parameters such that the Bluetooth communications (between the STA 115-d and the STA 115-c) and the WLAN communications (between the STA 115-d and the AP 105-b) are performed in non-overlapping time periods, thereby decreasing the probability of scheduling conflicts between the Bluetooth communications and the WLAN communications.

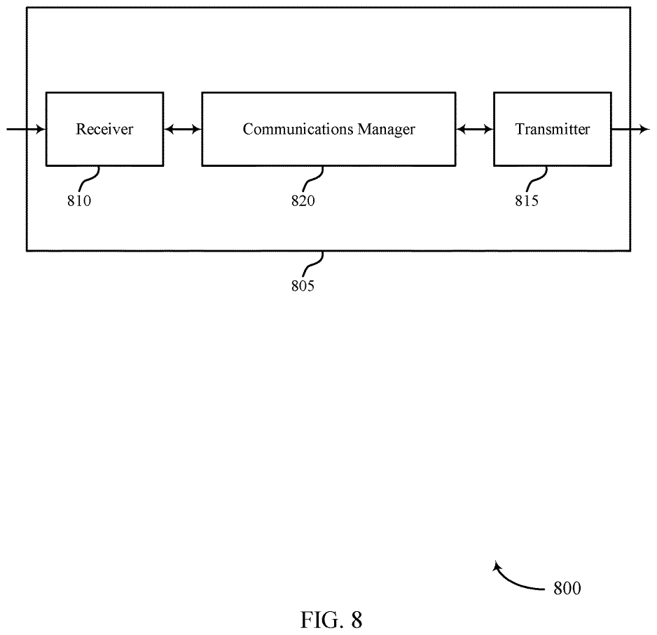

FIG. 8 shows a block diagram 800 of a device 805 that supports scheduling techniques for RAT coexistence in accordance with one or more aspects of the present disclosure. The device 805 may be an example of aspects of a STA 115, as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to scheduling techniques for RAT coexistence). Information may be passed on to other components of the device 805. The receiver 810 may utilize a single antenna or multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to scheduling techniques for RAT coexistence). In some examples, the transmitter 815 may be co-located with a receiver 810 in a transceiver module. The transmitter 815 may utilize a single antenna or multiple antennas.

The communications manager 820, the receiver 810, the transmitter 815, or various combinations thereof or various components thereof may be examples of means for performing various aspects of scheduling techniques for RAT coexistence, as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations, as described herein.

The communications manager 820 may support wireless communication at a STA (the device 805) in accordance with examples disclosed herein. For example, the communications manager 820 may be configured as or otherwise support a means for transmitting, to a wireless device, a first message indicating a time interval and a time window in the time interval that is available for communications between the STA and the wireless device via a first RAT. The communications manager 820 may be configured as or otherwise support a means for transmitting, to an AP, a second message indicating the time interval and a wake duration in the time interval that is available for communications between the STA and the AP via a second RAT, where the time window and the wake duration span different portions of the time interval. The communications manager 820 may be configured as or otherwise support a means for communicating a data message with the AP during the wake duration via the second RAT.

By including or configuring the communications manager 820 in accordance with examples, as described herein, the device 805 (e.g., a processor controlling or otherwise coupled with the receiver 810, the transmitter 815, the communications manager 820, or a combination thereof) may support techniques for more efficient utilization of communication resources by using different (non-overlapping) portions of an ISO interval for Bluetooth ISO traffic and WLAN traffic, thereby reducing the frequency of signal collisions and scheduling conflicts that occur between WLAN communications and Bluetooth ISO communications in a shared or unlicensed RF spectrum band.

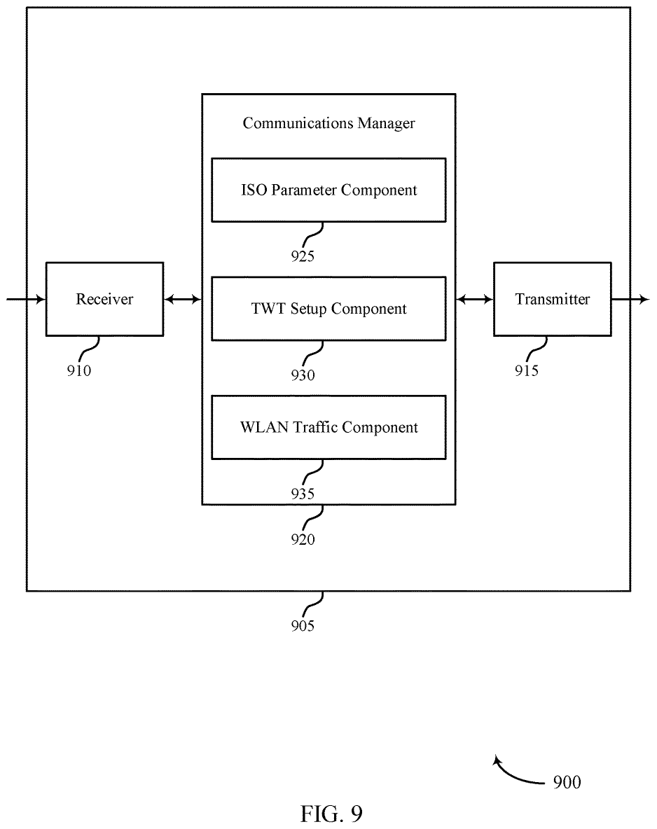

FIG. 9 shows a block diagram 900 of a device 905 that supports scheduling techniques for RAT coexistence in accordance with one or more aspects of the present disclosure. The device 905 may be an example of aspects of a device 805 or a STA 115, as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to scheduling techniques for RAT coexistence). Information may be passed on to other components of the device 905. The receiver 910 may utilize a single antenna or multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to scheduling techniques for RAT coexistence). In some examples, the transmitter 915 may be co-located with a receiver 910 in a transceiver module. The transmitter 915 may utilize a single antenna or multiple antennas.

The device 905, or various components thereof, may be an example of means for performing various aspects of scheduling techniques for RAT coexistence, as described herein. For example, the communications manager 920 may include an ISO parameter component 925, a TWT setup component 930, a WLAN traffic component 935, or any combination thereof. The communications manager 920 may be an example of aspects of a communications manager 820, as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations, as described herein.

The communications manager 920 may support wireless communication at a STA (the device 905) in accordance with examples disclosed herein. The ISO parameter component 925 may be configured as or otherwise support a means for transmitting, to a wireless device, a first message indicating a time interval and a time window in the time interval that is available for communications between the STA and the wireless device via a first RAT. The TWT setup component 930 may be configured as or otherwise support a means for transmitting, to an AP, a second message indicating the time interval and a wake duration in the time interval that is available for communications between the STA and the AP via a second RAT, where the time window and the wake duration span different portions of the time interval. The WLAN traffic component 935 may be configured as or otherwise support a means for communicating a data message with the AP during the wake duration via the second RAT.

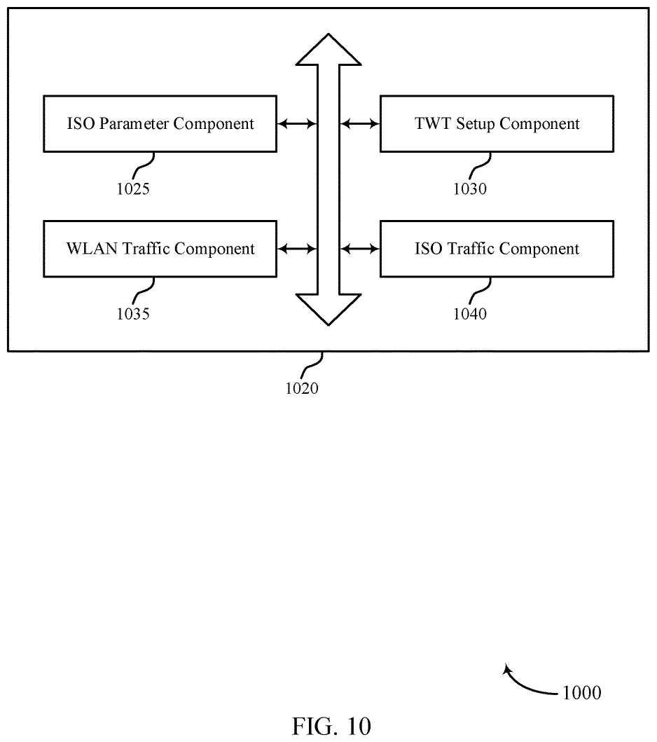

FIG. 10 shows a block diagram 1000 of a communications manager 1020 that supports scheduling techniques for RAT coexistence in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of scheduling techniques for RAT coexistence, as described herein. For example, the communications manager 1020 may include an ISO parameter component 1025, a TWT setup component 1030, a WLAN traffic component 1035, an ISO traffic component 1040, or any combination thereof. Each of these components may communicate, directly or indirectly, with one another (e.g., via one or more buses).

The communications manager 1020 may support wireless communication at a STA in accordance with examples disclosed herein. The ISO parameter component 1025 may be configured as or otherwise support a means for transmitting, to a wireless device, a first message indicating a time interval and a time window in the time interval that is available for communications between the STA and the wireless device via a first RAT. The TWT setup component 1030 may be configured as or otherwise support a means for transmitting, to an AP, a second message indicating the time interval and a wake duration in the time interval that is available for communications between the STA and the AP via a second RAT, where the time window and the wake duration span different portions of the time interval. The WLAN traffic component 1035 may be configured as or otherwise support a means for communicating a data message with the AP during the wake duration via the second RAT.

In some examples, the TWT setup component 1030 may be configured as or otherwise support a means for establishing a TWT session for the communications between the STA and the AP via the second RAT, where communicating the data message with the AP is based on establishing the TWT session.

In some examples, the TWT session is established using one or more parameters associated with the communications between the STA and the wireless device via the first RAT. In some examples, the TWT session is established based on a capability of the STA to support coexistence between the first RAT and the second RAT.

In some examples, to support establishing the TWT session, the TWT setup component 1030 may be configured as or otherwise support a means for exchanging one or more TWT action frames with the AP, where the one or more TWT action frames indicate one or more parameters for the TWT session.

In some examples, the ISO traffic component 1040 may be configured as or otherwise support a means for communicating a second data message with the wireless device during the time window via the first RAT in accordance with an ISO data transport scheme. In some examples, the second data message includes BLE streaming data.

In some examples, the data message is communicated during the wake duration in accordance with a periodic data transport scheme associated with the second RAT. In some examples, the data message is communicated in accordance with a WLAN frame exchange. In some examples, the data message includes a PM bit set to a first value. In some examples, the first RAT includes a Bluetooth RAT and the second RAT includes a WLAN RAT.

In some examples, the wake duration is equal to a difference between a duration of the time interval and a duration of the time window. In some examples, the time window spans a first portion of the time interval and the wake duration spans a remaining portion of the time interval.

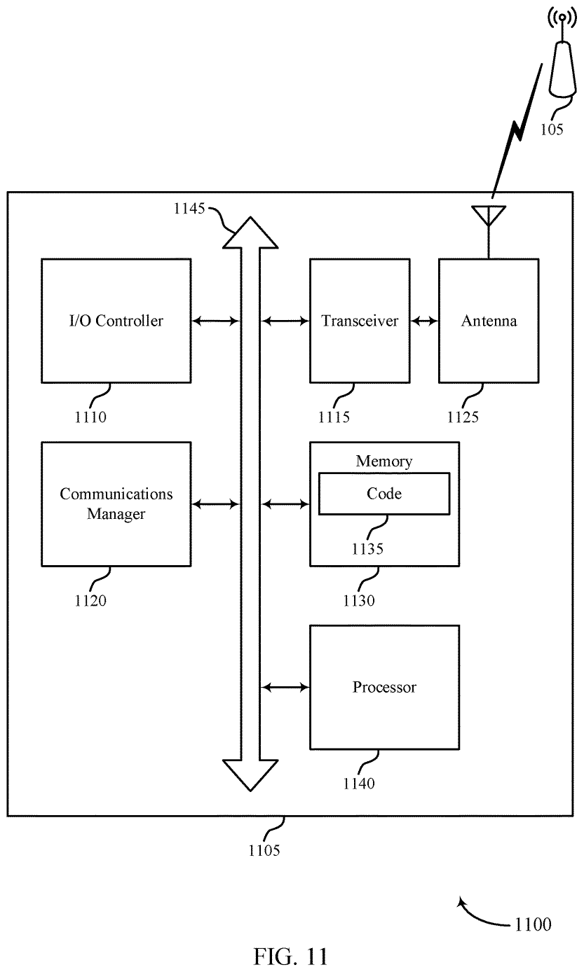

FIG. 11 shows a diagram of a system 1100 including a device 1105 that supports scheduling techniques for RAT coexistence in accordance with one or more aspects of the present disclosure. The device 1105 may be an example of or include the components of a device 805, a device 905, or a STA 115, as described herein. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. In some other cases, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links, as described herein. For example, the transceiver 1115 may represent a wireless transceiver and may communicate bi-directionally with another wireless transceiver. The transceiver 1115 may also include a modem to modulate the packets and provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. In some cases, the memory 1130 may contain, among other things, a basic I/O system (BIOS) which may control basic hardware or software operation such as the interaction with peripheral components or devices.

The processor 1140 may include an intelligent hardware device, (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting scheduling techniques for RAT coexistence). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a STA (the device 1105) in accordance with examples disclosed herein. For example, the communications manager 1120 may be configured as or otherwise support a means for transmitting, to a wireless device, a first message indicating a time interval and a time window in the time interval that is available for communications between the STA and the wireless device via a first RAT. The communications manager 1120 may be configured as or otherwise support a means for transmitting, to an AP, a second message indicating the time interval and a wake duration in the time interval that is available for communications between the STA and the AP via a second RAT, where the time window and the wake duration span different portions of the time interval. The communications manager 1120 may be configured as or otherwise support a means for communicating a data message with the AP during the wake duration via the second RAT.

By including or configuring the communications manager 1120 in accordance with examples, as described herein, the device 1105 may support techniques for improved communication reliability, reduced latency, and lower signaling overhead, among other benefits. For example, the device 1105 may use different (non-overlapping) portions of an ISO interval for WLAN traffic and Bluetooth ISO traffic, which may reduce the likelihood of the Bluetooth ISO traffic interfering with or otherwise degrading the quality of WLAN communications between the device 1105 and an AP associated with a WLAN RAT.

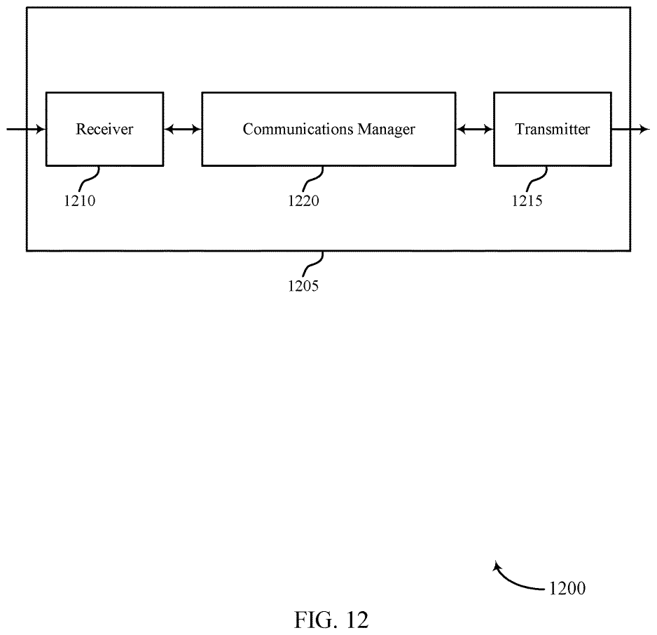

FIG. 12 shows a block diagram 1200 of a device 1205 that supports scheduling techniques for RAT coexistence in accordance with one or more aspects of the present disclosure. The device 1205 may be an example of aspects of an AP, as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to scheduling techniques for RAT coexistence). Information may be passed on to other components of the device 1205. The receiver 1210 may utilize a single antenna or multiple antennas.

The transmitter 1215 may provide a means for transmitting signals generated by other components of the device 1205. The transmitter 1215 may utilize a single antenna or multiple antennas.

The communications manager 1220, the receiver 1210, the transmitter 1215, or various combinations thereof or various components thereof may be examples of means for performing various aspects of scheduling techniques for RAT coexistence, as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations, as described herein.

The communications manager 1220 may support wireless communication at an AP (the device 1205) in accordance with examples disclosed herein. For example, the communications manager 1220 may be configured as or otherwise support a means for receiving, from a STA, a first message that indicates a time interval and a wake duration in the time interval that is available for communications between the AP and the STA via a second RAT, where the wake duration is based on a time window in the time interval that is available for communications between the STA and a wireless device via a first RAT. The communications manager 1220 may be configured as or otherwise support a means for communicating a data message with the STA during the wake duration via the second RAT, where the time window and the wake duration span different portions of the time interval.

By including or configuring the communications manager 1220 in accordance with examples, as described herein, the device 1205 (e.g., a processor controlling or otherwise coupled with the receiver 1210, the transmitter 1215, the communications manager 1220, or a combination thereof) may support techniques for more efficient utilization of communication resources by using different (non-overlapping) portions of an ISO interval for Bluetooth ISO traffic and WLAN traffic, thereby reducing the frequency of signal collisions and scheduling conflicts that occur between WLAN communications and Bluetooth ISO communications in a shared or unlicensed RF spectrum band.

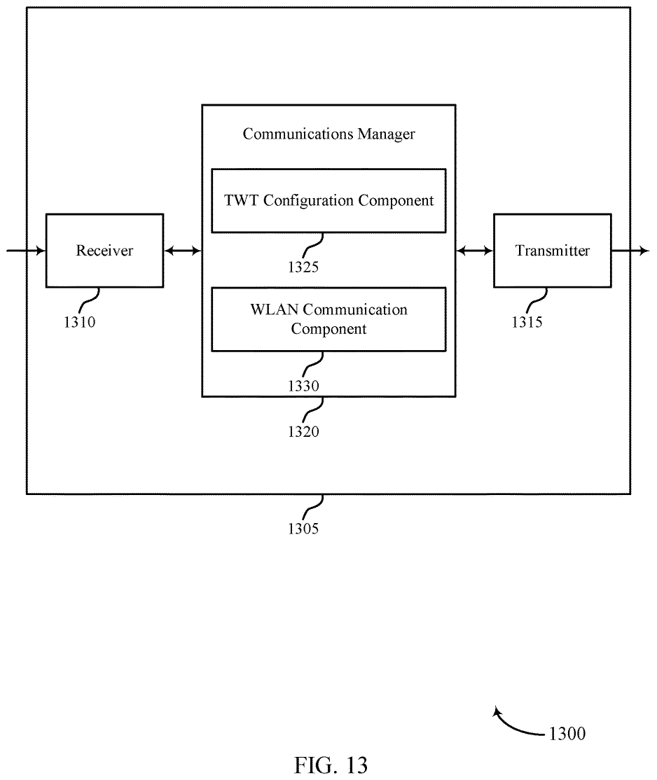

FIG. 13 shows a block diagram 1300 of a device 1305 that supports scheduling techniques for RAT coexistence in accordance with one or more aspects of the present disclosure. The device 1305 may be an example of aspects of a device 1205 or an AP 105, as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to scheduling techniques for RAT coexistence). Information may be passed on to other components of the device 1305. The receiver 1310 may utilize a single antenna or multiple antennas.

The transmitter 1315 may provide a means for transmitting signals generated by other components of the device 1305. The transmitter 1315 may utilize a single antenna or multiple antennas.

The device 1305, or various components thereof, may be an example of means for performing various aspects of scheduling techniques for RAT coexistence, as described herein. For example, the communications manager 1320 may include a TWT configuration component 1325 a WLAN communication component 1330, or any combination thereof. The communications manager 1320 may be an example of aspects of a communications manager 1220, as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations, as described herein.

The communications manager 1320 may support wireless communication at an AP (the device 1305) in accordance with examples disclosed herein. The TWT configuration component 1325 may be configured as or otherwise support a means for receiving, from a STA, a first message that indicates a time interval and a wake duration in the time interval that is available for communications between the AP and the STA via a second RAT, where the wake duration is based on a time window in the time interval that is available for communications between the STA and a wireless device via a first RAT. The WLAN communication component 1330 may be configured as or otherwise support a means for communicating a data message with the STA during the wake duration via the second RAT, where the time window and the wake duration span different portions of the time interval.

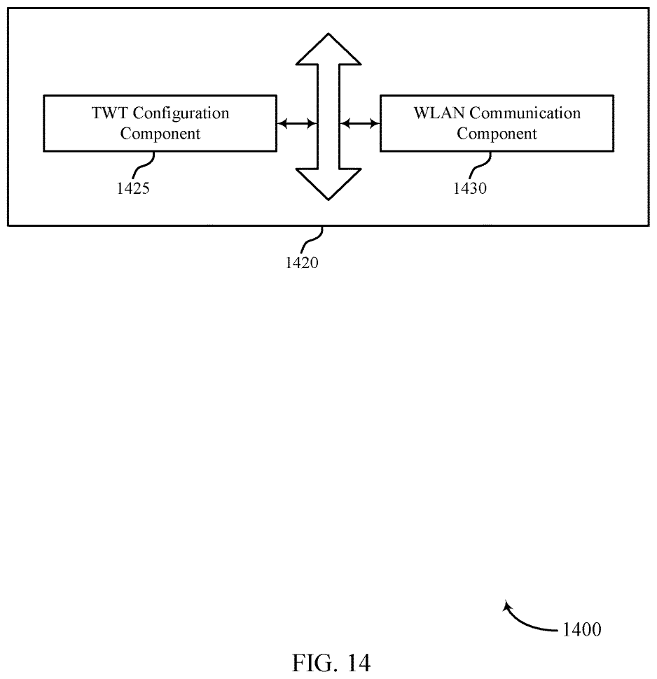

FIG. 14 shows a block diagram 1400 of a communications manager 1420 that supports scheduling techniques for RAT coexistence in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of scheduling techniques for RAT coexistence, as described herein. For example, the communications manager 1420 may include a TWT configuration component 1425 a WLAN communication component 1430, or any combination thereof. Each of these components may communicate, directly or indirectly, with one another (e.g., via one or more buses).

The communications manager 1420 may support wireless communication at an AP in accordance with examples disclosed herein. The TWT configuration component 1425 may be configured as or otherwise support a means for receiving, from a STA, a first message that indicates a time interval and a wake duration in the time interval that is available for communications between the AP and the STA via a second RAT, where the wake duration is based on a time window in the time interval that is available for communications between the STA and a wireless device via a first RAT. The WLAN communication component 1430 may be configured as or otherwise support a means for communicating a data message with the STA during the wake duration via the second RAT, where the time window and the wake duration span different portions of the time interval.

In some examples, the TWT configuration component 1425 may be configured as or otherwise support a means for establishing a TWT session for the communications between the STA and the AP via the second RAT, where communicating the data message with the STA is based on establishing the TWT session.

In some examples, the TWT session is established using one or more parameters associated with the communications between the STA and the wireless device via the first RAT. In some examples, the TWT session is established based on a capability of the STA to support coexistence between the first RAT and the second RAT.

In some examples, to support establishing the TWT session, the TWT configuration component 1425 may be configured as or otherwise support a means for exchanging one or more TWT action frames with the STA, where the one or more TWT action frames indicate one or more parameters for the TWT session.

In some examples, the data message is communicated during the wake duration in accordance with a periodic data transport scheme associated with the second RAT. In some examples, the data message is communicated in accordance with a WLAN frame exchange. In some examples, the data message includes a PM bit set to a first value. In some examples, the first RAT includes a Bluetooth RAT and the second RAT includes a WLAN RAT.

In some examples, the wake duration is equal to a difference between a duration of the time interval and a duration of the time window. In some examples, the time window spans a first portion of the time interval and the wake duration spans a remaining portion of the time interval.

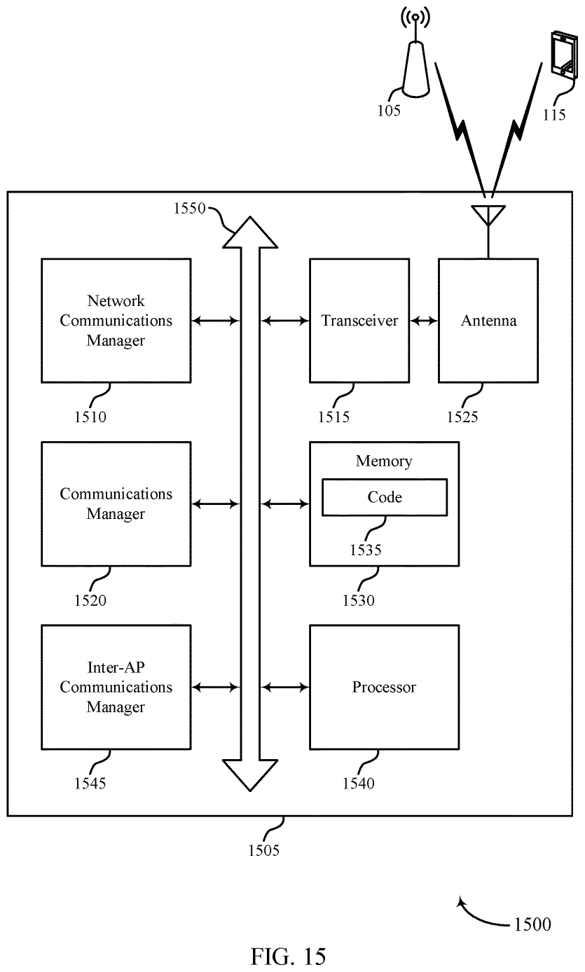

FIG. 15 shows a diagram of a system 1500 including a device 1505 that supports scheduling techniques for RAT coexistence in accordance with one or more aspects of the present disclosure. The device 1505 may be an example of or include the components of a device 1205, a device 1305, or an AP 105, as described herein. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-AP communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network (e.g., via one or more wired backhaul links). For example, the network communications manager 1510 may manage the transfer of data communications for client devices, such as one or more STAs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links, as described herein. For example, the transceiver 1515 may represent a wireless transceiver and may communicate bi-directionally with another wireless transceiver. The transceiver 1515 may also include a modem to modulate the packets and provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. In some cases, the memory 1530 may contain, among other things, a BIOS which may control basic hardware or software operation such as the interaction with peripheral components or devices.

The processor 1540 may include an intelligent hardware device, (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting scheduling techniques for RAT coexistence). For example, the device 1505 or a component of the device 1505 may include a processor 1540 and memory 1530 coupled with or to the processor 1540, the processor 1540 and memory 1530 configured to perform various functions described herein.

The inter-AP communications manager 1545 may manage communications with other APs 105, and may include a controller or scheduler for controlling communications with STAs 115 in cooperation with other APs 105. For example, the inter-AP communications manager 1545 may coordinate scheduling for transmissions to APs 105 for various interference mitigation techniques such as beamforming or joint transmission. In some examples, the inter-AP communications manager 1545 may provide an X2 interface within a Long Term Evolution (LTE) or LTE-Advanced (LTE-A) wireless communication network technology to provide communication between APs 105.

The communications manager 1520 may support wireless communication at an AP (the device 1505) in accordance with examples disclosed herein. For example, the communications manager 1520 may be configured as or otherwise support a means for receiving, from a STA, a first message that indicates a time interval and a wake duration in the time interval that is available for communications between the AP and the STA via a second RAT, where the wake duration being based on a time window in the time interval that is available for communications between the STA and a wireless device via a first RAT. The communications manager 1520 may be configured as or otherwise support a means for communicating a data message with the STA during the wake duration via the second RAT, where the time window and the wake duration span different portions of the time interval.

By including or configuring the communications manager 1520 in accordance with examples, as described herein, the device 1505 may support techniques for improved communication reliability, reduced latency, and lower signaling overhead, among other benefits. For example, the device 1505 may communicate WLAN traffic with a STA in an unused (available) portion of an ISO interval, thereby reducing the likelihood of Bluetooth communications interfering with or otherwise degrading the quality of WLAN communications between the device 1505 and the STA. As such, the device 1505 may perform fewer retransmissions, experience fewer delays, and remain in a low-power state for a longer duration (in comparison to other coexistence schemes).

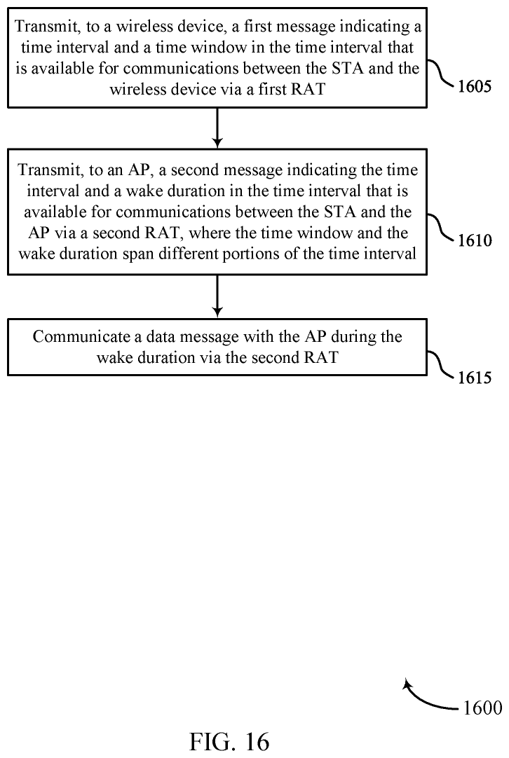

FIG. 16 shows a flowchart illustrating a method 1600 that supports scheduling techniques for RAT coexistence in accordance with one or more aspects of the present disclosure. The operations of the method 1600 may be implemented by a STA or components thereof. For example, the operations of the method 1600 may be performed by a STA 115, as described with reference to FIGS. 1 through 11. In some examples, the STA may execute a set of instructions to control the functional elements of the STA to perform the described functions. Additionally, or alternatively, the STA may perform aspects of the described functions using special-purpose hardware.

At 1605, the STA may transmit, to a wireless device, a first message indicating a time interval and a time window in the time interval that is available for communications between the STA and the wireless device via a first RAT. The operations of 1605 may be performed in accordance with examples disclosed herein. In some examples, aspects of the operations of 1605 may be performed by an ISO parameter component 1025, as described with reference to FIG. 10.

At 1610, the STA may transmit, to an AP, a second message indicating the time interval and a wake duration in the time interval that is available for communications between the STA and the AP via a second RAT, where the time window and the wake duration span different portions of the time interval. The operations of 1610 may be performed in accordance with examples disclosed herein. In some examples, aspects of the operations of 1610 may be performed by a TWT setup component 1030, as described with reference to FIG. 10.

At 1615, the STA may communicate a data message with the AP during the wake duration via the second RAT. The operations of 1615 may be performed in accordance with examples disclosed herein. In some examples, aspects of the operations of 1615 may be performed by a WLAN traffic component 1035, as described with reference to FIG. 10.

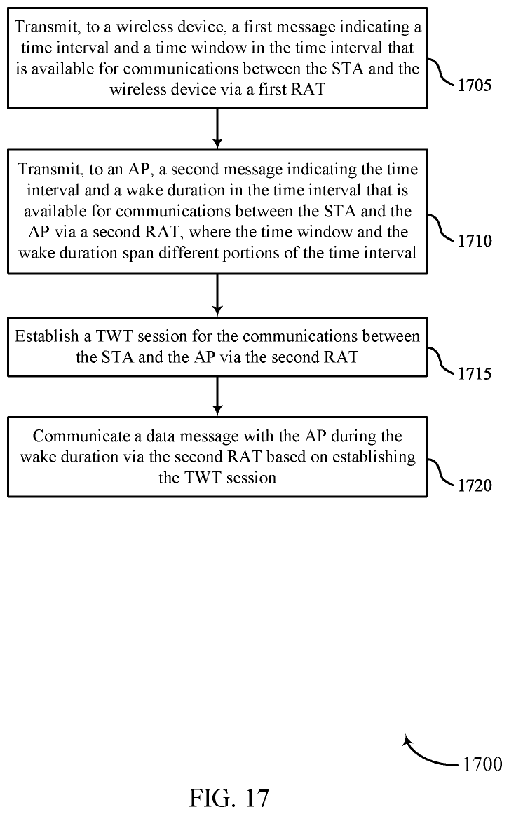

FIG. 17 shows a flowchart illustrating a method 1700 that supports scheduling techniques for RAT coexistence in accordance with one or more aspects of the present disclosure. The operations of the method 1700 may be implemented by a STA or components thereof. For example, the operations of the method 1700 may be performed by a STA 115, as described with reference to FIGS. 1 through 11. In some examples, the STA may execute a set of instructions to control the functional elements of the STA to perform the described functions. Additionally, or alternatively, the STA may perform aspects of the described functions using special-purpose hardware.

At 1705, the STA may transmit, to a wireless device, a first message indicating a time interval and a time window in the time interval that is available for communications between the STA and the wireless device via a first RAT. The operations of 1705 may be performed in accordance with examples disclosed herein. In some examples, aspects of the operations of 1705 may be performed by an ISO parameter component 1025, as described with reference to FIG. 10.

At 1710, the STA may transmit, to an AP, a second message indicating the time interval and a wake duration in the time interval that is available for communications between the STA and the AP via a second RAT, where the time window and the wake duration span different portions of the time interval. The operations of 1710 may be performed in accordance with examples disclosed herein. In some examples, aspects of the operations of 1710 may be performed by a TWT setup component 1030, as described with reference to FIG. 10.

At 1715, the STA may establish a TWT session for the communications between the STA and the AP via the second RAT. The operations of 1715 may be performed in accordance with examples disclosed herein. In some examples, aspects of the operations of 1715 may be performed by a TWT setup component 1030, as described with reference to FIG. 10.

At 1720, the STA may communicate a data message with the AP during the wake duration via the second RAT based on establishing the TWT session. The operations of 1720 may be performed in accordance with examples disclosed herein. In some examples, aspects of the operations of 1720 may be performed by a WLAN traffic component 1035, as described with reference to FIG. 10.

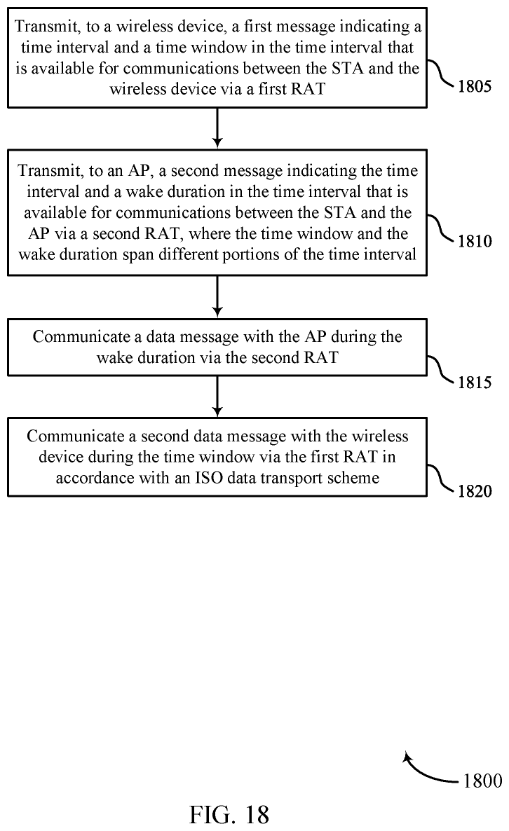

FIG. 18 shows a flowchart illustrating a method 1800 that supports scheduling techniques for RAT coexistence in accordance with one or more aspects of the present disclosure. The operations of the method 1800 may be implemented by a STA or components thereof. For example, the operations of the method 1800 may be performed by a STA 115, as described with reference to FIGS. 1 through 11. In some examples, the STA may execute a set of instructions to control the functional elements of the STA to perform the described functions. Additionally, or alternatively, the STA may perform aspects of the described functions using special-purpose hardware.

At 1805, the STA may transmit, to a wireless device, a first message indicating a time interval and a time window in the time interval that is available for communications between the STA and the wireless device via a first RAT. The operations of 1805 may be performed in accordance with examples disclosed herein. In some examples, aspects of the operations of 1805 may be performed by an ISO parameter component 1025, as described with reference to FIG. 10.

At 1810, the STA may transmit, to an AP, a second message indicating the time interval and a wake duration in the time interval that is available for communications between the STA and the AP via a second RAT, where the time window and the wake duration span different portions of the time interval. The operations of 1810 may be performed in accordance with examples disclosed herein. In some examples, aspects of the operations of 1810 may be performed by a TWT setup component 1030, as described with reference to FIG. 10.

At 1815, the STA may communicate a data message with the AP during the wake duration via the second RAT. The operations of 1815 may be performed in accordance with examples disclosed herein. In some examples, aspects of the operations of 1815 may be performed by a WLAN traffic component 1035, as described with reference to FIG. 10.

At 1820, the STA may communicate a second data message with the wireless device during the time window via the first RAT in accordance with an ISO data transport scheme. The operations of 1820 may be performed in accordance with examples disclosed herein. In some examples, aspects of the operations of 1820 may be performed by an ISO traffic component 1040, as described with reference to FIG. 10.

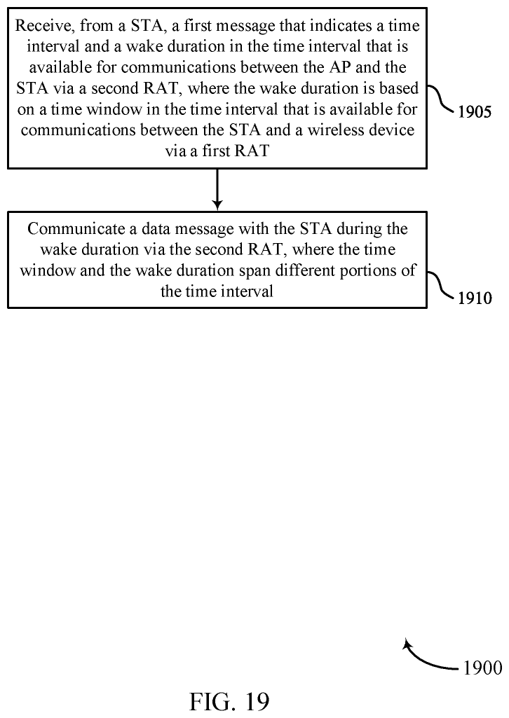

FIG. 19 shows a flowchart illustrating a method 1900 that supports scheduling techniques for RAT coexistence in accordance with one or more aspects of the present disclosure. The operations of the method 1900 may be implemented by an AP or components thereof. For example, the operations of the method 1900 may be performed by an AP 105, as described with reference to FIGS. 1 through 7 and 12 through 15. In some examples, the AP may execute a set of instructions to control the functional elements of the AP to perform the described functions. Additionally, or alternatively, the AP may perform aspects of the described functions using special-purpose hardware.

At 1905, the AP may receive, from a STA, a first message that indicates a time interval and a wake duration in the time interval that is available for communications between the AP and the STA via a second RAT, where the wake duration is based on a time window in the time interval that is available for communications between the STA and a wireless device via a first RAT. The operations of 1905 may be performed in accordance with examples disclosed herein. In some examples, aspects of the operations of 1905 may be performed by a TWT configuration component 1425, as described with reference to FIG. 14.

At 1910, the AP may communicate a data message with the STA during the wake duration via the second RAT, where the time window and the wake duration span different portions of the time interval. The operations of 1910 may be performed in accordance with examples disclosed herein. In some examples, aspects of the operations of 1910 may be performed by a WLAN communication component 1430, as described with reference to FIG. 14.

The following provides an overview of aspects of the present disclosure:

Aspect 1: A method for wireless communication at a station, comprising: transmitting, to a wireless device, a first message indicating a time interval and a time window in the time interval that is available for communications between the station and the wireless device via a first radio access technology; transmitting, to an access point, a second message indicating the time interval and a wake duration in the time interval that is available for communications between the station and the access point via a second radio access technology, wherein the time window and the wake duration span different portions of the time interval; and communicating a data message with the access point during the wake duration via the second radio access technology.

Aspect 2: The method of aspect 1, further comprising: establishing a target wake time session for the communications between the station and the access point via the second radio access technology, wherein the data message is communicated with the access point during the target wake time session.

Aspect 3: The method of aspect 2, wherein the target wake time session is established using one or more parameters associated with the communications between the station and the wireless device via the first radio access technology.

Aspect 4: The method of any of aspects 2 through 3, wherein the target wake time session is established based at least in part on a capability of the station to support coexistence between the first radio access technology and the second radio access technology.

Aspect 5: The method of any of aspects 2 through 4, wherein establishing the target wake time session comprises: exchanging one or more target wake time action frames with the access point, wherein the one or more target wake time action frames indicate one or more parameters for the target wake time session.

Aspect 6: The method of any of aspects 1 through 5, further comprising: communicating a second data message with the wireless device during the time window via the first radio access technology in accordance with an isochronous data transport scheme.

Aspect 7: The method of aspect 6, wherein the second data message comprises Bluetooth low energy streaming data.

Aspect 8: The method of any of aspects 1 through 7, wherein the data message is communicated during the wake duration in accordance with a periodic data transport scheme associated with the second radio access technology.

Aspect 9: The method of any of aspects 1 through 8, wherein the data message is communicated in accordance with a wireless local area network frame exchange; and the data message comprises a power management bit set to a first value.

Aspect 10: The method of any of aspects 1 through 9, wherein the first radio access technology comprises a Bluetooth radio access technology and the second radio access technology comprises a wireless local area network radio access technology.

Aspect 11: The method of any of aspects 1 through 10, wherein the wake duration is equal to a difference between a duration of the time interval and a duration of the time window.

Aspect 12: The method of any of aspects 1 through 11, wherein the time window spans a first portion of the time interval and the wake duration spans a remaining portion of the time interval.

Aspect 13: A method for wireless communication at an access point, comprising: receiving, from a station, a first message that indicates a time interval and a wake duration in the time interval that is available for communications between the access point and the station via a second radio access technology, wherein the wake duration is based at least in part on a time window in the time interval that is available for communications between the station and a wireless device via a first radio access technology; and communicating a data message with the station during the wake duration via the second radio access technology, wherein the time window and the wake duration span different portions of the time interval.

Aspect 14: The method of aspect 13, further comprising: establishing a target wake time session for the communications between the station and the access point via the second radio access technology, wherein the data message is communicated with the station during the target wake time session.

Aspect 15: The method of aspect 14, wherein the target wake time session is established using one or more parameters associated with the communications between the station and the wireless device via the first radio access technology.

Aspect 16: The method of any of aspects 14 through 15, wherein the target wake time session is established based at least in part on a capability of the station to support coexistence between the first radio access technology and the second radio access technology.

Aspect 17: The method of any of aspects 14 through 16, wherein establishing the target wake time session comprises: exchanging one or more target wake time action frames with the station, wherein the one or more target wake time action frames indicate one or more parameters for the target wake time session.

Aspect 18: The method of any of aspects 13 through 17, wherein the data message is communicated during the wake duration in accordance with a periodic data transport scheme associated with the second radio access technology.

Aspect 19: The method of any of aspects 13 through 18, wherein: the data message is communicated in accordance with a wireless local area network frame exchange; and the data message comprises a power management bit set to a first value.

Aspect 20: The method of any of aspects 13 through 19, wherein the first radio access technology comprises a Bluetooth radio access technology and the second radio access technology comprises a wireless local area network radio access technology.

Aspect 21: The method of any of aspects 13 through 20, wherein the wake duration is equal to a difference between a duration of the time interval and a duration of the time window.

Aspect 22: The method of any of aspects 13 through 21, wherein the time window spans a first portion of the time interval and the wake duration spans a remaining portion of the time interval.

Aspect 23: An apparatus for wireless communication at a station, comprising: a processor; memory coupled with the processor; and instructions stored in the memory and executable by the processor to cause the apparatus to perform a method of any of aspects 1 through 12.

Aspect 24: An apparatus for wireless communication at a station, comprising at least one means for performing a method of any of aspects 1 through 12.

Aspect 25: A non-transitory computer-readable medium storing code for wireless communication at a station, the code comprising instructions executable by a processor to perform a method of any of aspects 1 through 12.

Aspect 26: An apparatus for wireless communication at an access point, comprising: a processor; memory coupled with the processor; and instructions stored in the memory and executable by the processor to cause the apparatus to perform a method of any of aspects 13 through 22.

Aspect 27: An apparatus for wireless communication at an access point, comprising at least one means for performing a method of any of aspects 13 through 22.

Aspect 28: A non-transitory computer-readable medium storing code for wireless communication at an access point, the code comprising instructions executable by a processor to perform a method of any of aspects 13 through 22.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA 2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the STAs may have similar frame timing, and transmissions from different STAs may be approximately aligned in time. For asynchronous operation, the STAs may have different frame timing, and transmissions from different STAs may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, the wireless communications system 100 and the wireless communications system 200—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. An apparatus for wireless communication at a station, comprising:
a processor;
memory coupled with the processor; and
instructions stored in the memory and executable by the processor to cause the apparatus to:
transmit, to a wireless device, a first message indicating a time interval and a time window in the time interval that is available for communications between the station and the wireless device via a first radio access technology;
transmit, to an access point, a second message indicating the time interval and a wake duration in the time interval that is available for communications between the station and the access point via a second radio access technology,
wherein the time window and the wake duration span different portions of the time interval; and
communicate a data message with the access point during the wake duration via the second radio access technology.

2. The apparatus of claim 1, wherein the instructions are further executable by the processor to cause the apparatus to:
establish a target wake time session for the communications between the station and the access point via the second radio access technology,
wherein the data message is communicated with the access point during the target wake time session.

3. The apparatus of claim 2, wherein the target wake time session is established using one or more parameters associated with the communications between the station and the wireless device via the first radio access technology.

4. The apparatus of claim 2, wherein the target wake time session is established based at least in part on a capability of the station to support coexistence between the first radio access technology and the second radio access technology.

5. The apparatus of claim 2, wherein, to establish the target wake time session, the instructions are executable by the processor to cause the apparatus to:
exchange one or more target wake time action frames with the access point,
wherein the one or more target wake time action frames indicate one or more parameters for the target wake time session.

6. The apparatus of claim 1, wherein the instructions are further executable by the processor to cause the apparatus to:
communicate a second data message with the wireless device during the time window via the first radio access technology in accordance with an isochronous data transport scheme.

7. The apparatus of claim 6, wherein:
the second data message comprises Bluetooth low energy streaming data.

8. The apparatus of claim 1, wherein the data message is communicated during the wake duration in accordance with a periodic data transport scheme associated with the second radio access technology.

9. The apparatus of claim 1, wherein:
the data message is communicated in accordance with a wireless local access network frame exchange; and
the data message comprises a power management bit set to a first value.

10. The apparatus of claim 1, wherein the first radio access technology comprises a Bluetooth radio access technology and the second radio access technology comprises a wireless local access network radio access technology.

11. The apparatus of claim 1, wherein the wake duration is equal to a difference between a duration of the time interval and a duration of the time window.

12. The apparatus of claim 1, wherein the time window spans a first portion of the time interval and the wake duration spans a remaining portion of the time interval.

13. An apparatus for wireless communication at an access point, comprising:
a processor;
memory coupled with the processor; and
instructions stored in the memory and executable by the processor to cause the apparatus to:
receive, from a station, a first message that indicates a time interval and a wake duration in the time interval that is available for communications between the access point and the station via a second radio access technology,
wherein the wake duration is based at least in part on a time window in the time interval that is available for communications between the station and a wireless device via a first radio access technology; and
communicate a data message with the station during the wake duration via the second radio access technology,
wherein the time window and the wake duration span different portions of the time interval.

14. The apparatus of claim 13, wherein the instructions are further executable by the processor to cause the apparatus to:
establish a target wake time session for the communications between the station and the access point via the second radio access technology,
wherein the data message is communicated with the station during the target wake time session.

15-17. (canceled)

18. The apparatus of claim 13, wherein the data message is communicated during the wake duration in accordance with a periodic data transport scheme associated with the second radio access technology.

19. The apparatus of claim 13, wherein:
the data message is communicated in accordance with a wireless local access network frame exchange; and
the data message comprises a power management bit set to a first value.

20. The apparatus of claim 13, wherein the first radio access technology comprises a Bluetooth radio access technology and the second radio access technology comprises a wireless local access network radio access technology.

21. The apparatus of claim 13, wherein the wake duration is equal to a difference between a duration of the time interval and a duration of the time window.

22. The apparatus of claim 13, wherein the time window spans a first portion of the time interval and the wake duration spans a remaining portion of the time interval.

23. A method for wireless communication at a station, comprising:
transmitting, to a wireless device, a first message indicating a time interval and a time window in the time interval that is available for communications between the station and the wireless device via a first radio access technology;
transmitting, to an access point, a second message indicating the time interval and a wake duration in the time interval that is available for communications between the station and the access point via a second radio access technology,
wherein the time window and the wake duration span different portions of the time interval; and
communicating a data message with the access point during the wake duration via the second radio access technology.

24-30. (canceled)
